(19) United States
(12) Patent Application Publication
(10) Pub. No.: US 2011/0220712 A1
(43) Pub. Date: Sep. 15, 2011

(54) READING APPARATUS AND COMMODITY SALES DATA PROCESSING APPARATUS

(75) Inventor: Masayuki Nakaeda, Kanagawa (JP)

(73) Assignee: TOSHIBA TEC KABUSHIKI KAISHA, Tokyo (JP)

(21) Appl. No.: 13/045,753

(22) Filed: Mar. 11, 2011

(30) Foreign Application Priority Data
Mar. 11, 2010 (JP) 2010-054984

(51) Int. Cl. G06K 7/14; G06F 17/00

(52) U.S. Cl. 235/375; 235/470

(57) ABSTRACT

According to one embodiment, a reading apparatus includes a base unit, a first display, a scanner, and a coupling unit. The scanner reads commodity information. The coupling unit couples the first display and the scanner to the base unit to be pivotable integrally around a rotation center axis extending along an up down direction.

### CROSS-REFERENCE TO RELATED APPLICATION

This application is based upon and claims the benefit of priority from the prior Japanese Patent Application No. 2010-054984, filed on Mar. 11, 2010 the entire contents of which are incorporated herein by reference.

### FIELD

Embodiments described herein relate generally to a reading apparatus and a commodity sales data processing apparatus.

### BACKGROUND

In the past, there is a reading apparatus used in a retail store such as a supermarket. The reading apparatus includes a scanner, a display, and a base unit. The scanner reads a commodity code. The display displays information concerning a commodity, the commodity code of which is read by the scanner. The base unit supports the scanner and the display. For example, Japanese Patent No. 3669630 (Patent Document 1) discloses a reading apparatus in which a display is pivotable around an axis extending along the horizontal direction.

The size of a store, utensils in the store, and the like vary depending on the store. Therefore, there is a demand to make it possible to set reading apparatuses in various places. However, in the reading apparatus in the past, although an angle of the display with respect to a customer who faces the display can be changed, a degree of freedom of a setting place is small.

### BRIEF DESCRIPTION OF THE DRAWINGS

FIG. 1 is a perspective view of a commodity sales data processing apparatus according to a first embodiment;

FIG. 2 is a perspective view of the commodity sales data processing apparatus according to the first embodiment viewed from the rear side;

FIG. 3 is a perspective view of a state in which a display and a scanner of the commodity sales data processing apparatus according to the first embodiment are faced sideways;

FIG. 4 is a side view of the commodity sales data processing apparatus according to the first embodiment;

FIG. 5 is a front view of the commodity sales data processing apparatus according to the first embodiment;

FIG. 6 is a rear view of the commodity sales data processing apparatus according to the first embodiment;

FIG. 7 is a plan view of the commodity sales data processing apparatus according to the first embodiment;

FIG. 8 is a schematic diagram of the configuration of the commodity sales data processing apparatus according to the first embodiment;

FIG. 9 is a sectional view of a coupling unit viewed from an arrow A direction shown in FIG. 4;

FIG. 10 is a perspective view of a part of a reading apparatus of a commodity sales data processing apparatus according to a second embodiment; and

FIG. 11 is a diagram of the configuration of a commodity sales data processing system according to a third embodiment.

### DETAILED DESCRIPTION

An embodiment provides a reading apparatus having a relatively large degree of freedom of a setting place and a commodity sales data processing apparatus including the reading apparatus.

In general, according to one embodiment, a reading apparatus includes a base unit, a first display, a scanner, and a coupling unit. The scanner reads commodity information. The coupling unit couples the first display and the scanner to the base unit to be pivotable integrally around a rotation center axis extending along an up down direction.

In general, according to another embodiment, a commodity sales data processing apparatus includes the reading apparatus and an information processing unit. The information processing unit causes a storing unit to store a commodity, the commodity information of which is read by the scanner.

Embodiments are explained in detail below with reference to the accompanying drawings. Plural embodiments explained below include the same components. Therefore, in the following explanation, common reference numerals and signs are given to the same components and redundant explanation of the components is omitted. The embodiments are examples in which the commodity sales data processing apparatus is applied to a POS (Point of Sales) terminal.

An arrow “a” in the figure indicates upward in an up down direction of the POS terminal and the reading apparatus (the base unit). An arrow “b” in the figure indicates forward in a front back direction of the POS terminal and the reading apparatus (the base unit). An arrow “c” in the figure indicates a width direction (in other words, a left right direction) of the POS terminal and the reading apparatus (the base unit).

### First Embodiment

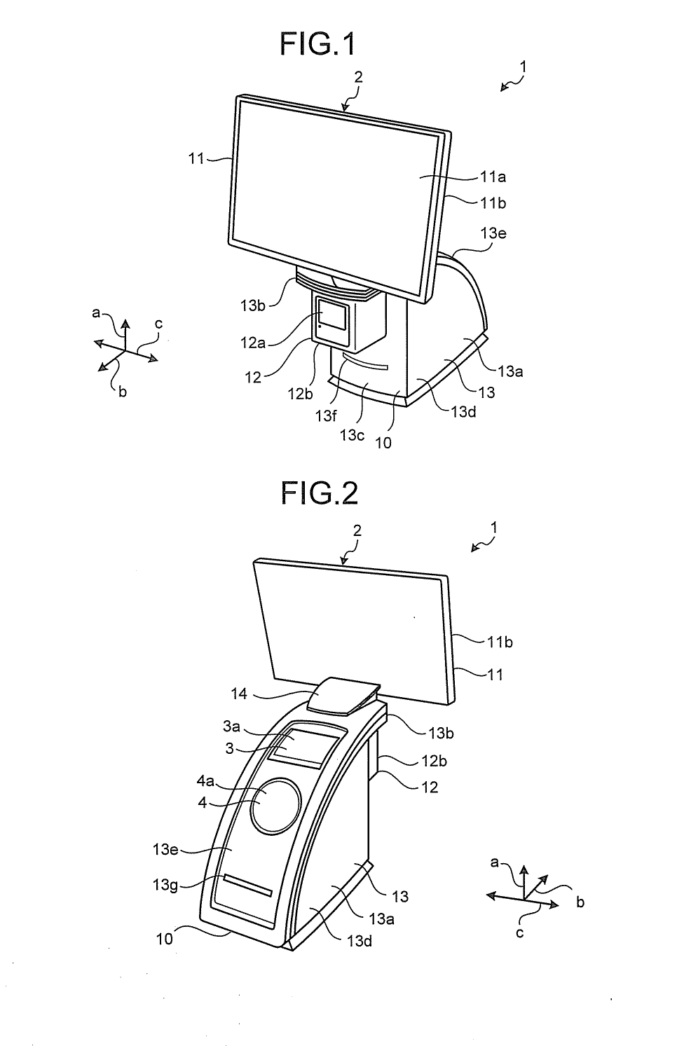

First, a first embodiment is explained with reference to FIGS. 1 to 9.

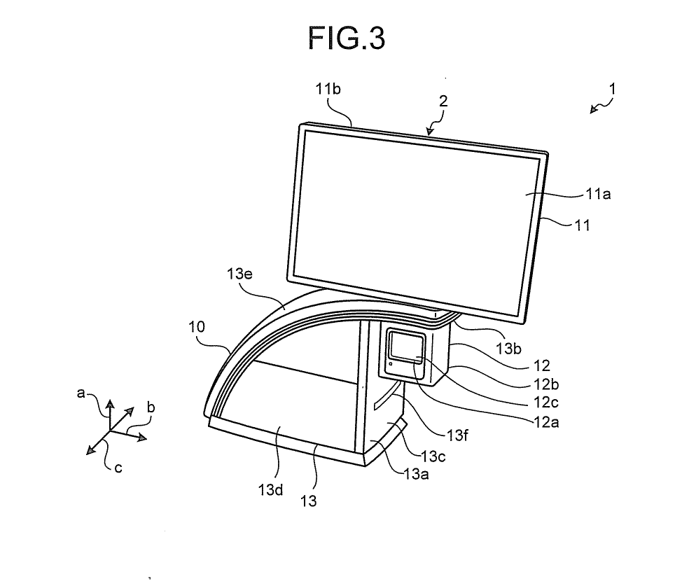

As shown in FIG. 1, a POS terminal 1 mainly includes a reading apparatus 2. The reading apparatus 2 includes a base unit 10, a first display 11, and a scanner 12. The first display 11 is a display mainly for a store clerk. As shown in FIG. 2, the base unit 10 includes a second display 3 and an electronic settlement unit 4. The second display 3 is a display mainly for a customer. In the reading apparatus 2, as shown in FIGS. 1 and 3, the first display 11 and the scanner 12 are pivotable with respect to the base unit 10.

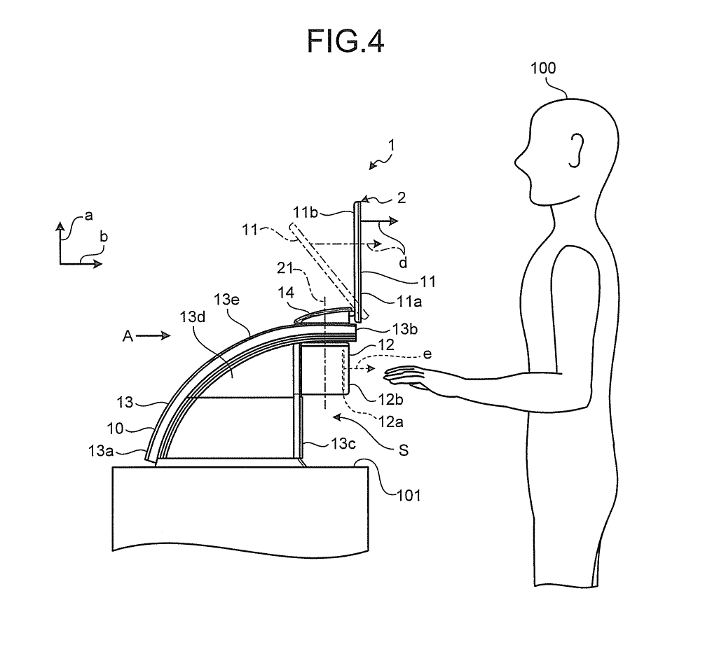

The base unit 10 includes a first housing 13. An information processing unit 5, a receipt printer (not shown), and the like are arranged on the inside of the first housing 13. The first housing 13 includes a fan-shaped section 13a and an overhang section 13b. As shown in FIG. 4, the fan-shaped section 13a is formed in a substantial fan shape in side view. The overhang section 13b overhangs forward from the upper end of the fan-shaped section 13a. The fan-shaped section 13a includes a front wall 13c, a pair of sidewalls 13d, and a curved wall 13e. The curved wall 13e curves in an arc shape.

As shown in FIG. 1, a first receipt issue port 13f is provided on the front wall 13c. As shown in FIG. 4, the curved wall 13e curves and extends backward obliquely downward from the upper end of the front wall 13c. As shown in FIG. 2, the second display 3, the electronic settlement unit 4, and a second receipt issue port 13g are provided on the curved wall 13e. A receipt printed by the receipt printer is issued from the first receipt issue port 13f or the second receipt issue port 13g. The scanner 12 and the first display 11 are pivotably attached to the overhang section 13b. A recess 13j is formed on the front wall 13c. The recess 13j is opposed to the scanner 12. A part of the scanner 12 is inserted into the recess 13j.

As shown in FIG. 1, the first display 11 includes a display screen 11a and a second housing 11b. The display screen 11a faces an operator 100 (see FIG. 4). The second housing 11b supports the display screen 11a. The first display 11 is, for example, a liquid crystal display. A touch panel is laminated on the first display 11. The first display 11 is capable of being tilted around an axis extending along the horizontal direction by a tilt mechanism 14. In FIG. 4, the first display 11 in a tilted state is indicated by an alternate long and short dash line. A keyboard (not shown) may be integrally provided in the first display 11.

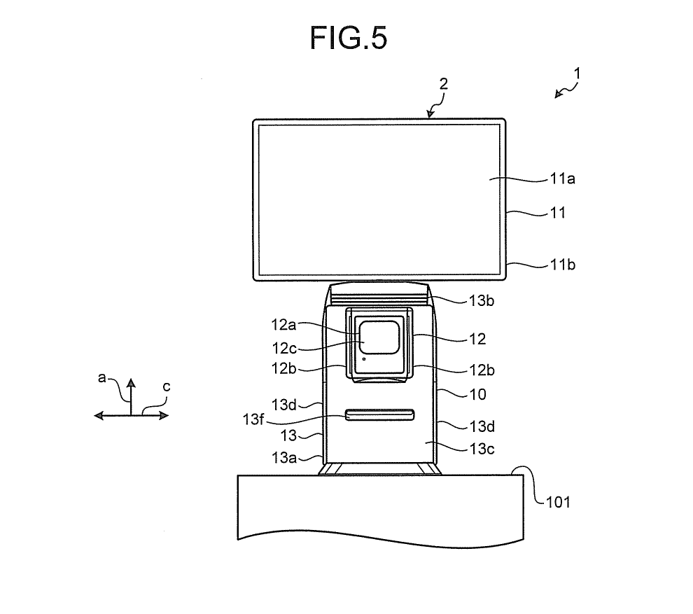

As shown in FIG. 5, the scanner 12 is arranged under the first display 11. The scanner 12 includes a reading window 12a. The reading window 12a faces the operator 100. The scanner 12 reads a commodity code (commodity identification information) located in front of the reading window 12a. The commodity code is commodity information. The commodity code is attached to a commodity. The operator 100 moves the commodity to the operator's side (the front) of the scanner 12.

Specifically, the scanner 12 optically reads a commodity code attached to a commodity in a form of a barcode. The scanner 12 includes a third housing 12b, a transparent panel 12c, a CCD camera (not shown), a lighting device (not shown), and a processing circuit unit (not shown). The reading window 12a is provided in the third housing 12b. The transparent panel 12c covers the reading window 12a. The CCD camera is arranged on the inside of the third housing 12b. The lighting device is arranged on the inside of the third housing 12b. The lighting device irradiates illumination light on the front of the reading window 12a. The illumination light is reflected by a section of the commodity including the barcode and made incident in the third housing 12b. The CCD camera receives the incident reflected light to image the barcode. The processing circuit unit extracts information such as the commodity code from a barcode image imaged in this way. If the base unit 10 is placed on a flat setting surface 101, a space S is formed between the setting surface 101 and the scanner 12. Devices such as a card reader writer can be arranged in the space S.

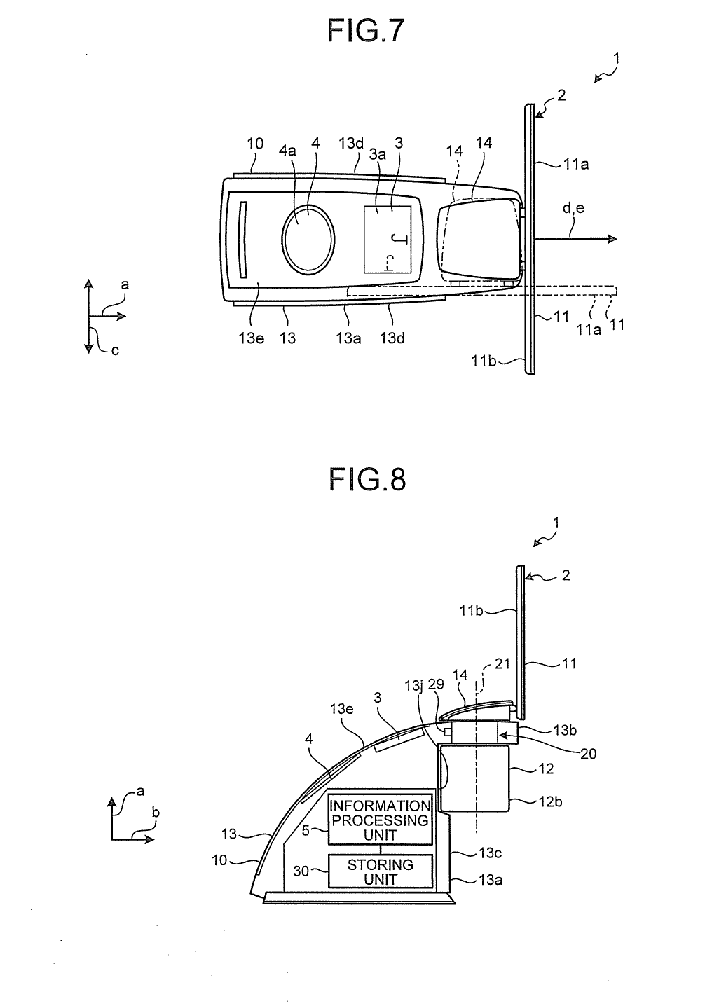

As explained in detail later, the scanner 12 is pivotable together with the first display 11 around a rotation center axis 21 extending along the up down direction. The orientation of the reading window 12a in a direction orthogonal to the rotation center axis 21 is the same as the orientation of the display screen 11a in the direction orthogonal to the rotation center axis 21. In FIGS. 4 and 7, the orientation of the reading window 12a in the direction orthogonal to the rotation center axis 21 is indicated by an arrow “e”. In FIGS. 4 and 7, the orientation of the display screen 11a in the direction orthogonal to the rotation center axis 21 is indicated by an arrow “d”. Since FIG. 7 is in plan view, the arrow “d” and the arrow “e” overlap each other. The orientation of the display screen 11a in the direction orthogonal to the rotation center axis 21 is the same irrespective of whether the first display 11 (the display screen 11a) is in a state in which the first display 11 (the display screen 11a) is along the up down direction (indicated by a solid line in FIG. 4) and a state in which the first display 11 (the display screen 11a) tilts with respect to the up down direction (indicated by an alternate long and short dash line in FIG. 4).

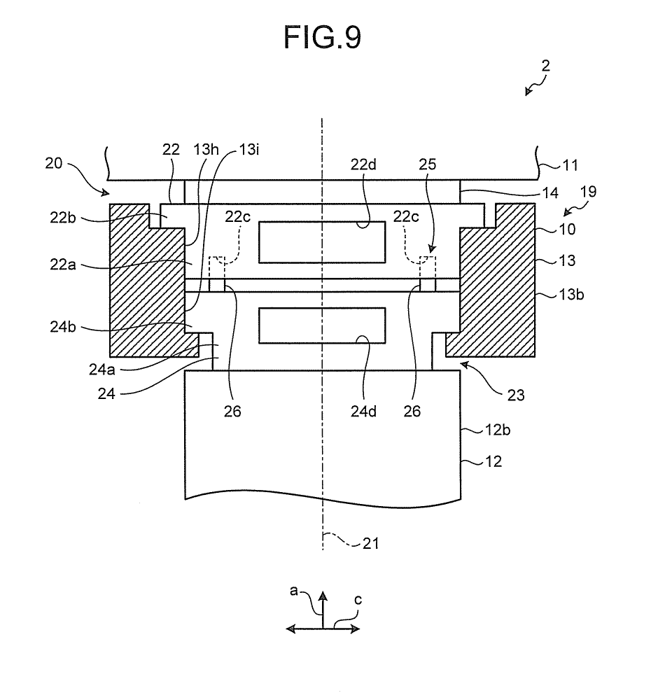

A coupling structure for coupling the first display 11 and the scanner 12 to the housing 13 is explained below. As shown in FIG. 9, the reading apparatus 2 includes a coupling unit 19. The coupling unit 19 couples the first display 11 and the scanner 12 to the base unit 10 to be integrally pivotable around the rotation center axis 21 extending along the up down direction. The coupling unit 19 couples the first display 11 to the base unit 10 to be pivotable between a first position (see FIG. 1) and a second position (see FIG. 3). The first position is a position where the display screen 11a of the first display 11 faces front forward of the base unit 10 (the direction of the arrow “b” in the figure). The second position is a position where the display screen 11a of the first display 11 faces one side of the base unit 10. As shown in FIG. 7, the first display 11 opens a space above the second display 3 in both the first and second positions. In FIG. 7, the first display 11 located in the first position is indicated by a solid line and the first display 11 located in the second position is indicated by an alternate long and two short dashes line.

Referring back to FIG. 9, the coupling unit 19 includes a coupling mechanism 20 and an interlocking section 23.

The coupling mechanism 20 couples the first display 11 to the base unit 10 to be pivotable around the rotation center axis 21.

The coupling mechanism 20 includes a first pivoting member 22 and a first supporting section 13h. The first pivoting member 22 is integrally provided in the first display 11. The first supporting section 13h is provided in the first housing 13. The first supporting section 13h pivotably supports the first pivoting member 22.

The first pivoting member 22 includes a first small-diameter section 22a and a first large-diameter section 22b. The first pivoting member 22 is formed in a stepped cylindrical shape. An axis direction of the first pivoting member 22 is along the up down direction. The first large-diameter section 22b is connected to the upper end of the first small-diameter section 22a. The first large-diameter section 22b has a diameter larger than that of the first small-diameter section 22a. The first display 11 is attached to the upper end of the first large-diameter section 22b via the tilt mechanism 14. The first supporting section 13h is formed in a stepped cylindrical shape. The first supporting section 13h slidably supports the lower surface of the first large-diameter section 22b. The first supporting section 13h slidably supports the circumferential surface of the first small-diameter section 22a. A center axis of the first pivoting member 22 and a center axis of the first supporting member 13h coincide with the rotation center axis 21.

A harness opening 22d is formed on a side surface of the first pivoting member 22. A display harness (not shown) is routed to the fan-shaped section 13a through the harness opening 22d. The display harness extends from the first display 11 and passes through the first pivoting member 22.

The scanner 12 is supported by the interlocking section 23. The interlocking section 23 pivots the scanner 12 including the reading window 12a in a direction same as the pivoting direction of the first display 11 including the display screen 11a in association with the pivotal movement of the first display 11. The interlocking section 23 includes a second pivoting member 24, a second supporting section 13i, and a coupling section 25. The second pivoting member 24 is integrally provided in the scanner 12. The second supporting section 13i is provided in the first housing 13. The second supporting section 13i pivotably supports the second pivoting member 24. The coupling section 25 couples the first pivoting member 22 and the second pivoting member 24.

The second pivoting member 24 is arranged below the first pivoting member 22. The second pivoting member 24 is arranged on an axis same as the axis of the first pivoting member 22. The second pivoting member 24 includes a second small-diameter section 24a and a second large-diameter section 24b. The second pivoting member 24 is formed in a stepped cylindrical shape. An axis direction of the second pivoting member 24 is along the up down direction. The second large-diameter section 24b is connected to the upper end of the second small-diameter section 24a. The second large-diameter section 24b has a diameter larger than the diameter of the second small-diameter section 24a. The scanner 12 is attached to the lower end of the second small-diameter section 24a. The second supporting section 13i is formed in a stepped cylindrical shape. The second supporting section 13i slidably supports the lower surface of the second large-diameter section 24b. The second supporting section 13i slidably supports the circumferential surface of the first small-diameter section 22a.

The coupling section 25 includes plural recesses 22c and plural pins 26. The plural recesses 22c are provided at the lower end of the first pivoting member 22. The plural pins 26 are provided at the upper end of the second pivoting member 24. The pins 26 are respectively inserted in the recesses 22c corresponding thereto. The recesses 22c are formed in a concave shape upward from the lower surface of the first pivoting member 22. The recesses 22c are arranged spaced apart from one another around the center axis of the first pivoting member 22. On the other hand, the pins 26 are provided to extend upward from the upper surface of the second pivoting member 24. The pins 26 are arranged spaced apart from one another around the center axis of the second pivoting member 24 to correspond to the recesses 22c. The first pivoting member 22 and the second pivoting member 24 are coupled by the coupling section 25.

A harness opening 24d is formed on a side surface of the second pivoting member 24. A scanner harness (not shown) is routed to the fan-shaped section 13a through the harness opening 24d. The scanner harness extends from the scanner 12 and passes through the second pivoting member 24.

As shown in FIG. 8, the reading apparatus 2 includes a detecting unit 29. The detecting unit 29 detects a pivoting position of the first display 11. The detecting unit 29 may include, for example, an angle sensor. In this case, the detecting unit 29 inputs a pivoting angle to the information processing unit 5 as a pivoting position. As another example, the detecting unit 29 may include a first switch and a second switch (both of which are not shown). In this case, if the first display 11 moves to the first position, the first switch is pushed by an engaging section (not shown) of the coupling unit 19 and outputs a first ON signal. If the first display 11 moves to the second position, the second switch is pushed by the engaging section (not shown) of the coupling unit 19 and outputs a second ON signal. The detecting unit 29 inputs the first ON signal and the second ON signal to the information processing unit 5.

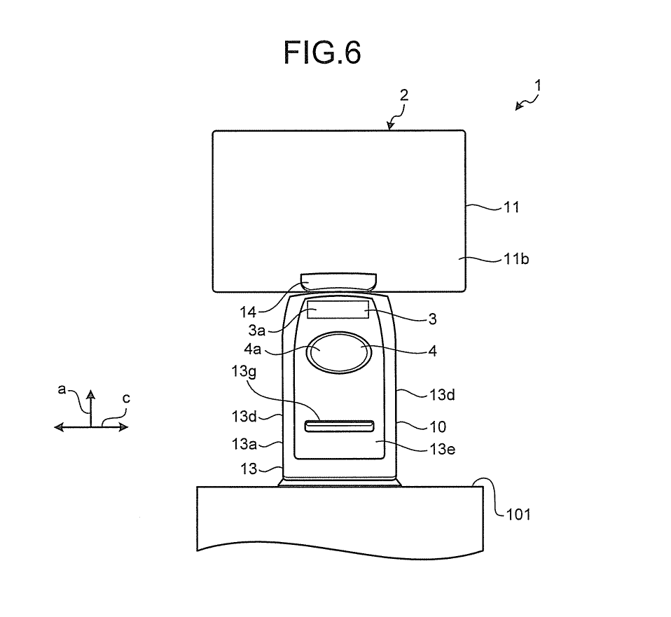

The electronic settlement unit 4 shown in FIG. 2 performs short-distance wireless communication with a noncontact IC card (not shown) and transmits and receives information related to settlement to and from the noncontact IC card. The wireless communication is performed using a radio wave for short-distance wireless communication. The radio wave for short-distance wireless communication is, for example, a radio wave used in RFID (Radio Frequency Identification). The noncontact IC card has stored therein, as the information related to settlement, information such as a balance of electronic money of a prepaid type and card identification information. The noncontact IC card is an electronic settlement device. Specifically, the electronic settlement unit 4 includes a reading surface 4a. As shown in FIG. 6, the reading surface 4a is provided on the curved wall 13e of the base unit 10 below the second display 3. The electronic settlement unit 4 performs communication with the noncontact IC card opposed to the reading surface 4a.

The second display 3 is, for example, a liquid crystal display device. The second display 3 is smaller than the first display 11.

As shown in FIG. 8, the POS terminal 1 includes the information processing unit 5. The information processing unit 5 is, for example, a CPU (Central Processing Unit). The information processing unit 5 is arranged in a lower part on the inside of the first housing 13. The information processing unit 5 executes various arithmetic operations and control of the units of the POS terminal 1 according to computer programs stored in a storing unit 30 (FIG. 8). The storing unit 30 includes a ROM (Read Only Memory) and a RAM (Random Access Memory). The ROM stores therein various computer programs to be executed by the information processing unit 5 and various data. When the information processing unit 5 executes the various computer programs, the RAM temporarily stores the data and the computer programs.

The scanner 12, the first display 11, the second display 3, the electronic settlement unit 4, and the detecting unit 29 are connected to the information processing unit 5 via a bus line or the like. A HDD (Hard Disk Drive) and a communication interface are connected to the information processing unit 5 via the bus line or the like. The HDD stores therein a computer program for causing the information processing unit 5 to operate. The HDD stores therein, for example, a commodity master file in which commodity information such as commodity names and unit prices for respective commodity codes is stored and a sales file in which sales data is stored.

The information processing unit 5 performs commodity sales processing. In the commodity sales processing, the information processing unit 5 registers a commodity, a commodity code of which is read by the scanner 12, in the RAM of the storing unit 30. Specifically, the information processing unit 5 receives input of the commodity code read by the scanner 12. The information processing unit 5 reads out commodity information corresponding to the received commodity code from the commodity master file. Subsequently, the information processing unit 5 generates, based on the commodity information read out from the commodity master file and a sales amount of the commodity, sales data indicating a sales record of the commodity. The information processing unit 5 performs sales registration of the commodity by storing the generated sales data in the RAM. In performing the sales registration, the information processing unit 5 causes the first display 11 and the second display 3 to display a commodity name, a unit price, and the like of the sales data. If a closing button displayed on the first display 11 is selected by touch on the touch panel, the information processing unit 5 creates receipt information of the commodity subjected to the sales registration. The information processing unit 5 causes the receipt printer to print and issue a receipt based on the created receipt information.

The information processing unit 5 performs display changing processing. In the display changing processing, the information processing unit 5 changes, according to a detection result of the detecting unit 29, the orientation of an image displayed on the first display 11. If the first display 11 is located in the second position, the information processing unit 5 pivots the orientation of the image displayed on the first display 11 by about 90 degrees with respect to the orientation of an image displayed if the first display 11 is located in the first position. In this embodiment, the information processing unit 5 changes the orientation of the image displayed on the first display 11 in a direction same as a direction and at an angle substantially same as an angle in the pivotal movement of the first display 11. In FIG. 7 is a diagram of an example in which “J” is displayed on the display screen 11a of the first display 11 as an image. In FIG. 7, the image “J” displayed if the first display 11 is located in the first position is indicated by a solid line. On the other hand, the image “J” displayed if the first display 11 is located in the second position is indicated by an alternate long and two short dashes line. In this embodiment, the information processing unit 5 is equivalent to a display control unit.

In such a configuration, the operator 100 pivots the first display 11 around the rotation center axis 21, whereby the interlocking section 23 pivots the scanner 12 in a direction same as the pivoting direction of the first display 11 in association with the pivotal movement of the first display 11. Therefore, for example, it is possible to selectively set the reading apparatus 2 in a form shown in FIG. 1 and a form shown in FIG. 3. Consequently, it is possible to change the pivoting angles of the first display 11 and the scanner 12 with respect to the base unit 10 according to a setting place. Therefore, it is possible to easily set the reading apparatus 2 in a form corresponding to the setting place.

As explained above, in this embodiment, the coupling mechanism 20 couples the first display 11 to the base unit 10 to be pivotable around the rotation center axis 21 extending along the up down direction of the reading apparatus 2. The interlocking section 23 pivots the scanner 12 in a direction same as the pivoting direction of the first display 11 in association with the pivotal movement of the first display 11. Therefore, there is an advantage that a degree of freedom of setting places of the reading apparatus 2 and the POS terminal 1 including the reading apparatus 2 is large.

In this embodiment, the scanner 12 is arranged below the first display 11. Therefore, if the operator 100 holds a commodity over the reading window 12a of the scanner 12, the operator 100 can easily view information displayed on the first display 11.

In this embodiment, the coupling mechanism 20 includes the first pivoting member 22 and the first supporting section 13h. The first pivoting member 22 is integrally provided in the first display 11. The first supporting section 13h is provided in the base unit 10. The first supporting section 13h pivotably supports the first pivoting member 22. The interlocking section 23 includes the second pivoting member 24, the second supporting section 13i, and the coupling section 25. The second pivoting member 24 is integrally provided in the scanner 12. The second supporting section 13i is provided in the base unit 10. The second supporting section 13i pivotably supports the second pivoting member 24. The coupling section 25 couples the first pivoting member 22 and the second pivoting member 24. Therefore, the pivotal movement of the first pivoting member 22 is transmitted to the second pivoting member 24 by the coupling section 25. The scanner 12 pivots following the pivotal movement of the first display 11.

In this embodiment, if the base unit 10 is placed on the flat setting surface 101, the space S is formed between the setting surface 101 and the scanner 12. Therefore, various devices such as a card reader writer can be set in the space S.

### Second Embodiment

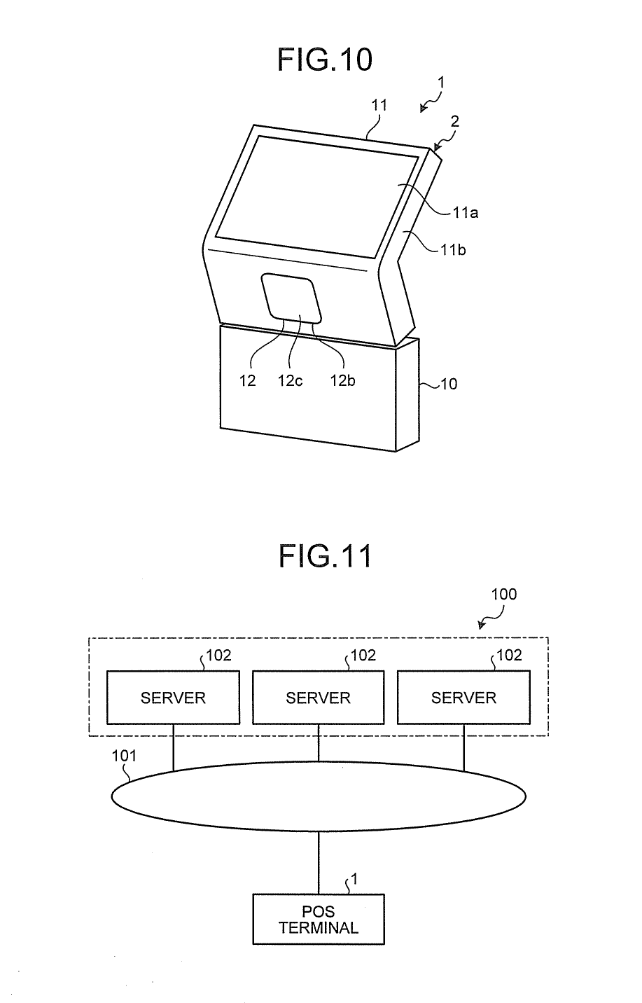

A second embodiment is explained with reference to FIG. 10. This embodiment is different from the first embodiment in an interlocking section. The interlocking section pivots the scanner 12 in a direction same as the pivoting direction of the first display 11 in association with the pivotal movement of the first display 11. In this embodiment, the scanner 12 is integrally provided in the first housing 13 of the first display 11. The first housing 13 functions as the interlocking section. In this case, the first pivoting member 22 (not shown in FIG. 10) is located behind the scanner 12 and coupled to the first housing 13.

As explained above, in this embodiment, the first display 11 includes the first housing 13 functioning as the interlocking section. The first housing 13 supports the display screen 11a. The scanner 12 is integrally provided in the first housing 13. Therefore, it is possible to realize the interlocking section 23 in a relatively simple configuration.

### Third Embodiment

A third embodiment is explained with reference to FIG. 11.

A commodity sales data processing system 100 according to this embodiment includes a POS terminal 1 and plural servers 102 connected to be capable of performing data communication with each other via a wired or wireless communication network (e.g., the Internet) 101 or the like.

In the commodity sales data processing system 100, one or plural servers 102 provide the POS terminal 1 with a predetermined service. In the commodity sales data processing system 100, a service can be provided in a form of cloud computing such as a SaaS (Software as a Service). For example, in this embodiment, the servers 102 perform at least a part of various kinds of processing executed by the information processing unit 5 of the POS terminal 1 in the first embodiment. The kinds of processing performed by the servers 102 are the commodity sales processing, the display changing processing, and the like.

The invention is not limited to the embodiments. Various other embodiments can be adopted without departing from the spirit of the invention. For example, the reading apparatus may be a reading apparatus that does not include the second display and the electronic settlement unit and outputs a read commodity code to an external apparatus.

According to the embodiments, it is possible to provide a reading apparatus and a commodity sales data processing apparatus having a relatively large degree of freedom of a setting place.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reading apparatus comprising:
a base unit;
a first display;
a scanner configured to read commodity information; and
a coupling unit configured to couple the first display and the scanner to the base unit to be pivotable integrally around a rotation center axis extending along an up down direction.

2. The apparatus according to claim 1, wherein the coupling unit includes:
a coupling mechanism configured to couple the first display to the base unit to be pivotable around the rotation center axis; and
an interlocking section configured to pivot the scanner in a direction same as a pivoting direction of the first display in association with the pivotal movement of the first display.

3. The apparatus according to claim 1, wherein
the first display includes a display screen, and
the scanner includes a reading window, an orientation of which in a direction orthogonal to the rotation center axis is the same as an orientation of the display screen in the direction orthogonal to the rotation center axis, and reads commodity information located in front of the reading window.

4. The apparatus according to claim 1, wherein the scanner is arranged below the first display.

5. The apparatus according to claim 2, wherein
the coupling mechanism includes:
a first pivoting member integrally provided in the first display; and
a first supporting section provided in the base unit and configured to pivotably support the first pivoting member, and
the interlocking section includes:
a second pivoting member integrally provided in the scanner;
a second supporting section provided in the base unit and configured to pivotably support the second pivoting member; and
a coupling section configured to couple the first pivoting member and the second pivoting member.

6. The apparatus according to claim 2, wherein
the first display includes a housing functioning as the interlocking section,
the housing supports the display screen, and
the scanner is integrally provided in the housing.

7. The apparatus according to claim 1, wherein, if the base unit is placed on a flat setting surface, a space is formed between the setting surface and the scanner.

8. The apparatus according to claim 1, further comprising:
a second display provide in the base unit; and
an electronic settlement unit including a reading surface, which is provided in the base unit below the second display, and configured to perform communication with an electronic settlement medium opposed to the reading surface.

9. The apparatus according to claim 1, further comprising a second display arranged on an upper surface of the base unit, wherein
the first display includes a display screen,
the coupling mechanism couples the first display to the base unit to be pivotable between a first position where the display screen faces front forward of the base unit and a second position where the display screen faces one side of the base unit, and
the first display opens a space above the second display in both the first and second positions.

10. The apparatus according to claim 1, further comprising:
a detecting unit configured to detect a pivoting position of the first display, and
a display control unit configured to change, according to a detection result of the detecting unit, an orientation of an image displayed on the display screen.

11. The apparatus according to claim 10, further comprising a second display arranged on an upper surface of the base unit, wherein
the first display includes a display screen,
the coupling unit couples the first display to the base unit to be pivotable between a first position where the display screen faces front forward of the base unit and a second position where the display screen faces one side of the base unit,
the first display opens a space above the second display in both the first and second positions, and
if the first display is located in the second position, the display control unit pivots an orientation of an image displayed on the first display by about 90 degrees with respect to an orientation of an image displayed if the first display is located in the first position.

12. A commodity sales data processing apparatus comprising:
the reading apparatus according to claim 1; and
an information processing unit configured to cause a storing unit to store a commodity, the commodity information of which is read by the scanner.
